(19) United States
(12) Patent Application Publication
(10) Pub. No.: US 2021/0342940 A1
(43) Pub. Date: Nov. 4, 2021

(54) METHOD, SYSTEM, AND MEDIUM FOR BLOCKCHAIN-ENABLED ATOMIC SETTLEMENT

(71) Applicant: Polymath Inc., St. Thomas (BB)

(72) Inventors: Adam DOSSA, London (GB); Nicholas CAFARO, Toronto (CA); Mudit GUPTA, Noida (IN)

(21) Appl. No.: 17/371,620

(22) Filed: Jul. 9, 2021

(30) Foreign Application Priority Data
Aug. 31, 2020 (CA) 3091660

(51) Int. Cl. G06Q 40/04; G06Q 20/40

(52) U.S. Cl. CPC G06Q 40/04; G06Q 20/401

(57) ABSTRACT

Methods, systems, and techniques for performing blockchain-enabled atomic settlement. A first instruction, which includes a first leg specifying a first counterparty and a second counterparty that are counterparties to a first transaction and an amount of a first asset owned by the first counterparty, is obtained. The first instruction is confirmed to be authorized; this involves locking the first asset without transferring the first asset in response to obtaining that confirmation. The first instruction is executed after the first instruction is confirmed to be authorized. Executing the first instruction involves transferring the first asset from the first counterparty to the second counterparty. That the first instruction has been executed is recorded in a blockchain.

### CROSS-REFERENCE TO RELATED APPLICATIONS

The present application claims priority to Canadian patent application no. 3,091,660, filed on Aug. 31, 2020, and entitled “Method, System, and Medium for Blockchain-Enabled Atomic Settlement”, the entirety of which is hereby incorporated by reference herein.

### TECHNICAL FIELD

The present disclosure is directed at methods, systems, and techniques for blockchain-enabled atomic settlement.

### BACKGROUND

As used herein, “settlement” refers to a process involving two or more parties in which beneficial ownership of an asset is transferred from one party to another party in exchange for value. While certain attempts have been made to automate settlement electronically, technical shortcomings have limited the practicality and effectiveness of those attempts.

### SUMMARY

According to a first aspect, there is provided a method comprising: obtaining a first instruction comprising a first leg specifying a first counterparty and a second counterparty that are counterparties to a first transaction and an amount of a first asset owned by the first counterparty; confirming that the first instruction is authorized, wherein confirming that the first instruction is authorized comprises locking the first asset in response to obtaining confirmation without transferring the first asset; executing the first instruction after the first instruction is confirmed to be authorized, wherein executing the first instruction comprises transferring the first asset from the first counterparty to the second counterparty; and recording in a blockchain that the first instruction has been executed.

The first instruction may further comprise a second leg specifying the first counterparty, the second counterparty, and an amount of a second asset owned by the second counterparty to be transferred to the first counterparty in exchange for the first asset; confirming that the first instruction is authorized may further comprise locking the second asset in response to obtaining confirmation without transferring the second asset; and executing the first instruction after the first instruction is confirmed to be authorized may further comprise transferring the second asset from the second counterparty to the first counterparty.

Confirming that the first instruction is authorized may comprise receiving confirmation from the first and second counterparty systems that the first instruction is authorized.

Locking the second asset may comprise recording in the blockchain that the second asset is locked.

Obtaining the first instruction, confirming that the first instruction is authorized, and executing the first instruction may be performed using computer program code that implements a protocol layer of the blockchain.

The method may further comprise generating an instruction generator before obtaining the first instruction, wherein the instruction generator generates the first instruction.

The first asset may be issued by an issuer, and the method may further comprise prior to generating the instruction generator comprising the first instruction: receiving a message from an exchange system to generate the instruction generator; and receiving a message from an issuer system granting the instruction generator permission to generate instructions to transfer the first asset; and recording in the blockchain that the instruction generator has permission to generate the instructions to transfer the first asset.

The method may further comprise prior to generating the instruction generator comprising the first instruction, receiving a message from the exchange system to generate the first instruction and the first leg that specifies the counterparties and the asset to be transferred; and recording the first instruction in the blockchain.

The method may further comprise recording in the blockchain a status of the first instruction indicating that the first instruction is pending execution.

Locking the first asset may comprise recording in the blockchain that the first asset is locked.

The method may further comprise obtaining a second instruction that comprises a second leg specifying a third counterparty and a fourth counterparty that are counterparties to a second transaction and an amount of a second asset owned by the third counterparty; confirming that the second instruction is authorized, wherein confirming that the second instruction is authorized comprises locking the second asset in response to obtaining confirmation from the third counterparty system without transferring the second asset; executing the second instruction after the third and fourth counterparty systems confirm that the second instruction is authorized, wherein executing the second instruction comprises transferring the second asset from the third counterparty to the fourth counterparty; and recording in the blockchain that the second instruction has been executed.

The method may further comprise obtaining a second instruction that comprises a second leg specifying a third counterparty and a fourth counterparty that are counterparties to a second transaction and an amount of a second asset owned by the third counterparty; attempting and failing to confirm with third and fourth counterparty systems that the second instruction is authorized; and in response to failing to confirm that the second instruction is authorized, recording in the blockchain that the second instruction has failed to execute.

At least one of the counterparties of the first transaction may also be at least one of the counterparties of the second transaction.

The first instruction may further comprise one or more additional legs that collectively specify one or more additional counterparties to the first transaction and amounts of one or more additional assets to be transferred between the counterparties to the first transaction. The method may comprise confirming with one or more additional counterparty systems that the first instruction is authorized, wherein confirming with the one or more additional counterparty systems that the first instruction is authorized comprises locking the one or more additional assets in response to obtaining confirming from the one or more additional counterparty systems without transferring the one or more additional assets. Executing the first instruction may comprise determining a net amount of the assets to be transferred between the counterparties, wherein determining the net amount comprises setting off amounts owed between the counterparties against each other; and transferring the net amount between the counterparties.

The first instruction may automatically execute upon the blockchain achieving a certain block height.

An agent may act on behalf of at least one of the counterparties.

According to another aspect, there is provided a system comprising multiple servers networked together to form a blockchain, wherein each of the servers comprises: network interface hardware for interfacing with the other servers; a non-transitory computer readable medium; a processor communicatively coupled to the network interface hardware and the non-transitory computer readable medium, wherein the non-transitory computer readable medium has stored thereon computer program code that is executable by the processor and that, when executed by the processor, causes the processor to perform any of the foregoing aspects of the method and suitable combinations thereof.

According to another aspect, there is provided a non-transitory computer readable medium having stored thereon computer program code that is executable by a processor and that, when executed by the processor, causes the processor to perform any of the foregoing aspects of the method and suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a system for blockchain-enabled atomic settlement, according to an example embodiment.

FIG. 2 depicts a computer system that comprises part of the system of FIG. 1.

FIG. 3 depicts a protocol stack implemented using the system of FIG. 1.

FIG. 4 depicts a flowchart depicting actions taken to effect blockchain-enabled atomic settlement, according to an example embodiment.

FIGS. 5A and 5B depicts a workflow depicting various on-chain and off-chain actions and blockchain state changes taken to effect blockchain-enabled atomic settlement, according to an example embodiment.

FIG. 6 depicts an instruction generator, atomic instruction grouping, and a single leg used in blockchain-enabled atomic settlement, according to an example embodiment implemented using the system of FIG. 1.

FIG. 7 depicts an instruction generator, atomic instruction grouping, and multiple legs used in blockchain-enabled atomic settlement, according to an example embodiment implemented using the system of FIG. 1.

FIG. 8 depicts an instruction generator, three atomic instruction groupings, and multiple legs for each of those groupings used in blockchain-enabled atomic settlement, according to an example embodiment implemented using the system of FIG. 1.

FIG. 9 depicts an instruction generator, atomic instruction grouping, and multiple legs used in blockchain-enabled atomic settlement in which a net settlement is determined and executed, according to an example embodiment implemented using the system of FIG. 1.

### DETAILED DESCRIPTION

In a conventional settlement process, a first counterparty selling an asset and a second counterparty buying that asset agree to trade, while reserving actual transfer, of that asset. At a time after that agreement, the asset is actually transferred from the first counterparty to the second counterparty in exchange for payment; this actual transfer of the asset in exchange for payment “settles” the trade. A conditional settlement process whereby the delivery of the asset and payment for that asset between the counterparties is linked in such a way to ensure that the transfer of the asset by the selling counterparty occurs if and only if the payment by the purchasing counterparty also occurs is referred to as “atomic settlement”. Atomic settlement permits “delivery vs. payment”, or “DvP”, in which the asset and payment of a trade are concurrently exchanged.

Various attempts have been made to use electronic means, including blockchain, for settlement. One technical problem encountered when attempting blockchain-enabled settlement is how to solve the “double spend” problem, which is how to prevent a counterparty from intentionally or unintentionally promising to pay the same asset in more than one transaction, in a technically efficient manner. When the asset to be transferred is a number of cryptographic tokens, one conventional solution to this problem is for a counterparty to send those tokens to an intermediary that holds them as a custodian and eventually uses them to settle the trade. This is problematic in that it requires the counterparty to divest itself of those tokens sometimes for a significant period of time before settlement actually occurs. Similarly, certain existing blockchain solutions require an account to be “pre-funded”; again, this requires the counterparty to divest itself of the asset to be exchanged.

In at least some example embodiments described herein, methods, systems, and techniques are described for blockchain-enabled atomic settlement. Settlement may be performed directly between the counterparties using electronic means and without transferring ownership of the assets being transferred to a custodian prior to settlement. Further, in at least some embodiments the settlement process is cryptographically secure and the settlement engine is implemented using the protocol layer of a blockchain. Cryptographic security and blockchain help create a reliable audit trail, both by ensuring that the identities of the first and second counterparties are authentic, that the messages they send have not been tampered with, and by immutably storing settlement-related instructions and transfers.

Implementing this solution requires solving one or more technical problems. For example, a technical implementation for locking assets belonging to one or more counterparties is used to enable DvP, and asynchronous communication between different computer systems and software modules are managed to securely, efficiently, and reliably effect settlement. As another example, security and interoperability between various assets that may be used for settlement are facilitated in at least some embodiments by implementing solutions in the protocol layer (layer 1) of the blockchain, as opposed to as smart contracts in the application layer.

More particularly, in at least some example embodiments a settlement engine obtains an instruction in which a transaction is divided into one or more legs. For example, the instruction may comprise a first leg specifying a first counterparty and a second counterparty that are counterparties to a transaction and an amount of a first asset owned by the first counterparty. The settlement engine confirms that the instruction is authorized, and then the settlement engine locks the first asset without the first counterparty divesting itself of the first asset. The settlement engine then executes the first instruction, with that execution comprising transferring the first asset from the first counterparty to the second counterparty. The fact that the first instruction is executed and the first asset is consequently transferred is recorded on a blockchain. In at least some embodiments, the instruction is obtained by using an instruction generator is used to generate the instruction. In at least some other example embodiments, the instruction may come from off the blockchain in a signed message.

Further, in at least some example embodiments such as the ones discussed in more detail below, computer program code that comprises part of the blockchain's protocol layer is used to obtain the instruction, lock the first asset, subsequently execute the first instruction, and record on the blockchain that the first instruction has been executed.

As used herein, a blockchain comprises computer nodes on which a distributed database is collectively stored. The database is stored as a chain of “blocks”. The first block in the blockchain is known as a “genesis block”, and every other block in the blockchain is directly linked in a cryptographically secure manner to an immediately preceding block in the chain. This is one way in which any one of the nodes can confirm the integrity of the blockchain.

New blocks added to the blockchain are referred to as being “higher” in the blockchain than the blocks added to the blockchain prior to it; the genesis block is accordingly the “lowest” block in the blockchain. Because each block in the blockchain is directly linked to its immediately preceding block, any block in the blockchain can, directly or indirectly, be traced back to the genesis block.

Different blockchains may be implemented in different ways. In one example blockchain, the bitcoin blockchain, each block of the blockchain comprises that block's size, in bytes; a block header; a transaction counter, representing the number of different bitcoin transactions stored in that block; and transaction data, which are the stored transactions. The block header for each block comprises version information; a previous block hash, which is a reference to the hash of the block immediately preceding that block; a Merkle root, which is a hash of the Merkle tree root of the transactions stored in that block; a timestamp, which is when the block was created; a difficulty target, which is the minimum difficulty that had to be satisfied when performing a proof-of-work operation during block creation; and a nonce, resulting from the proof-of-work.

Using the bitcoin blockchain as an example, different nodes forming the blockchain compete to generate new blocks by performing a proof-of-work operation that satisfies the difficulty target specified in each of the new blocks' headers. Once generated, a new block is disseminated to, and its authenticity is independently verified by, other nodes in the blockchain by using the previous block hash (to confirm that new block's lineage) and Merkle root (to confirm the validity of the transactions stored in that new block). Following verification, the new block is added to the top of the blockchain. The bitcoin blockchain at any given time is typically the chain having blocks resulting from the highest possible cumulative proof-of-work. The nodes are said to have arrived at “consensus” when they agree as to which block is to be added to the top of the blockchain. Each block is cryptographically linked to its immediately preceding block; consequently, blocks far from the top of the blockchain are, for practical purposes, immutable. While proof-of-work is how the bitcoin blockchain determines consensus, different blockchains may achieve consensus differently.

Nodes that successfully produce a new block that is included in the blockchain are typically rewarded with the protocol token of the blockchain, which in the case of the bitcoin blockchain are bitcoin tokens. Other types of blockchains have different protocol tokens; for example, the Ethererum™ blockchain's protocol tokens are referred to as Ether™ tokens. As another example, protocol tokens may be protocol layer or application layer tokens, depending on the particular blockchain implementation. Regardless of the specific blockchain implementation, these protocol tokens are typically used to pay for subsequent transactions on the blockchain, with the node that produces a block also usually retaining these fees in addition to their block reward. In addition to protocol tokens used to reward block creation, blockchains may be used to exchange tokenized assets. Tokenized assets permit counterparties to exchange assets with each other in a cryptographically secure manner. In at least some example embodiments, and in contrast to existing blockchain settlement implementations, the blockchain secures both the ownership of its protocol token, as well as cryptographic ownership of tokenized assets. Since these tokenized assets are managed at the protocol layer, and not the application layer, the settlement engine described herein can be used to settle instructions across any arbitrary set of tokenized assets in a uniform and consistent manner, with standardization of the assets being transferred enforced by the protocol layer itself rather than being delegated to the application layer. While the foregoing examples describe protocol tokens as a reward for new block creation/achieving consensus, in at least some example embodiments and blockchain implementations, protocol tokens and/or rewards may not be used for consensus.

For example, in the Ethereum™ blockchain, assets are tokenized as ERC-20 tokens at the application layer. These tokens may, or may not, implement customized functionality; regardless, they lack any enforcement of standards at the blockchain's protocol layer. This is in contrast to the example embodiments described herein, in which assets are tokenized at the blockchain's protocol layer so all tokenized assets are implicitly interoperable for the purposes of settlement without any application layer being required. References to “assets” being transferred herein comprise tokenized assets, which may represent assets such as, without limitation, digital currencies and securities tokens.

Each counterparty who wishes to be able to send and receive tokenized assets has a digital wallet that stores one or more public/private key pairs. For each pair, the private key is kept secret by that counterparty and the public key is made publicly available. One or more tokens may be transferred from a first counterparty to a second counterparty with this transfer being recorded in the blockchain. For example, the blockchain may record that a number of tokens have been transferred from the first counterparty to a public address (hereinafter interchangeably referred to as a “blockchain address”) of the second counterparty, with that address being based on the second counterparty's public key. The first counterparty digitally signs the transaction using the first counterparty's private key for authentication purposes. The transfer is then recorded on the blockchain with which the cryptographic token is associated, which requires another block to be added to that blockchain. A reference to the settlement engine settling a trade by “transferring” a an asset from the first counterparty to the second counterparty refers to the blockchain recording a transfer in which the tokenized asset is sent to the second user's public address in this or an analogous manner. A reference to a tokenized asset being “stored” in a digital wallet refers to that token having been sent to a public address generated from a public key associated with that wallet. While in some example embodiments the blockchain address of a counterparty may be that counterparty's public key, in at least some other embodiments the public address may be based on that counterparty's identity, which is based on its public key.

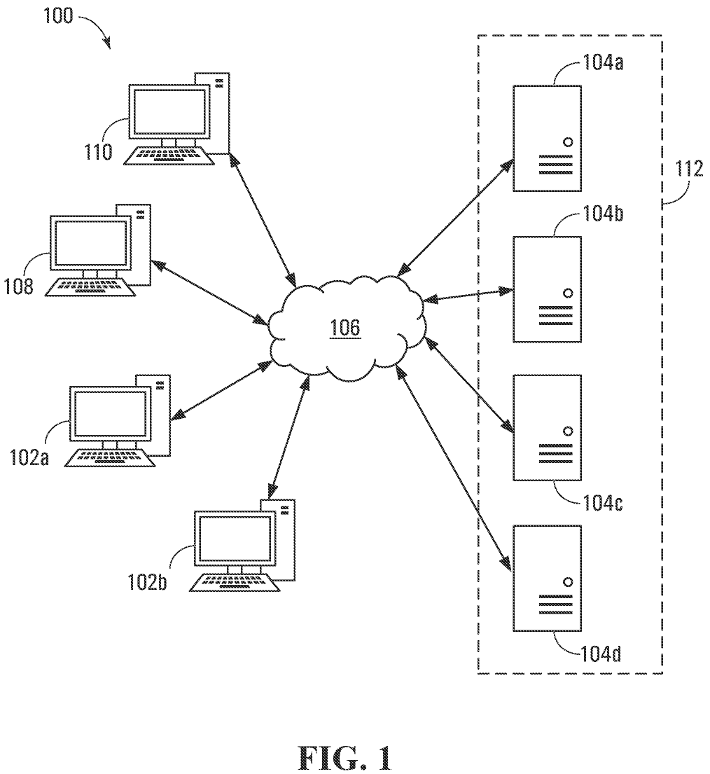

Referring now to FIG. 1, there is shown an example embodiment of a system 100 for atomic settlement, according to an example embodiment. The system 100 comprises a network 106, which may be one or both of a local area network or a wide area network such as the Internet. Computer systems used by two example counterparties, a first counterparty and a second counterparty, are respectively a first counterparty system 102a and a second counterparty system 102b (generally, “counterparty systems 102”) and are communicatively coupled to the network 106. First through fourth servers 104a-d (generally, “servers 104”) are also communicatively coupled to the network 106, as are an issuer system 110 used by an asset issuer and an exchange system 108 used by an exchange. Each of the counterparty systems 102, servers 104, exchange system 108, and issuer system 110 accordingly can communicate with each other via the network 106. As discussed further below, the servers 104 collectively form a blockchain 112 used to implement a settlement engine. While in the depicted example embodiments the counterparties are acting themselves, in at least some other embodiments, one or more of the counterparties may act through an agent, and that agent may act on behalf of its counterparty; consequently, in at least some embodiments a reference to a “counterparty” includes a reference to that counterparty's agent.

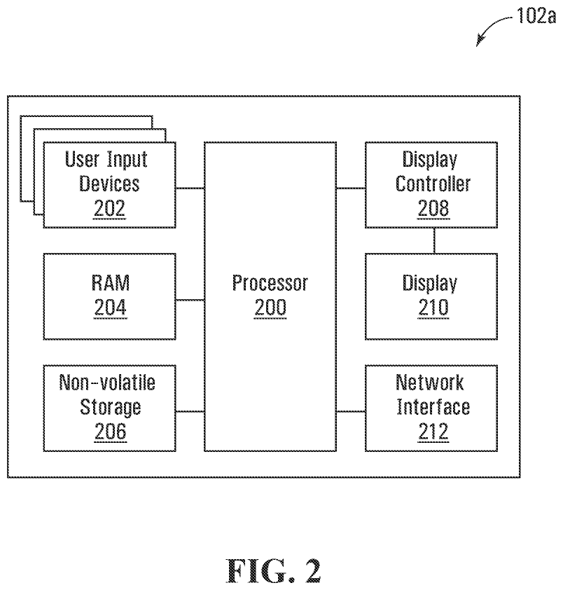

FIG. 2 shows a block diagram of the first counterparty system 102a, which is identical to the second counterparty system 102b. In FIG. 2, the first counterparty system 104a comprises a processor 200 that controls the system's 102a overall operation. The processor 200 is communicatively coupled to and controls subsystems comprising user input devices 202 (e.g., any one or more of a keyboard, mouse, touch screen, and voice control); random access memory (“RAM”) 204, which stores computer program code that is executed at runtime by the processor 200; non-volatile storage 206 (e.g., a solid state drive), which stores the computer program code loaded into the RAM 220 for execution at runtime and other data, such as the blocks of a blockchain; a display controller 208, which is communicatively coupled to and controls a display 210; and a network interface 212, which facilitates network communications with the other systems 102b,108,110 and servers 104 via the network 106. While FIG. 2 depicts the system used by the counterparties, analogous systems are used for the exchange system 108, issuer system 110, and servers 104. For example, the servers 104 may be rack mounted and accordingly omit the display 210.

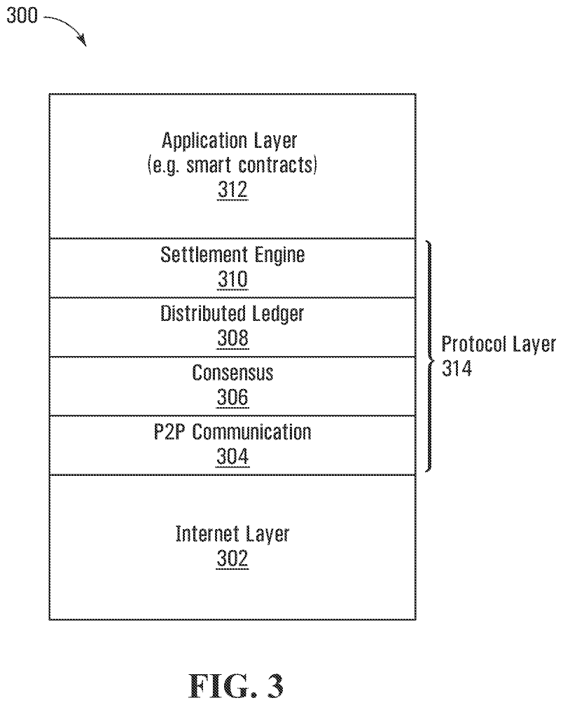

Implemented in the non-volatile storage 206 of the servers 104 is a protocol stack 300 depicted in FIG. 3. The protocol stack 300 comprises three layers: an Internet layer 302 that is at the base of the stack; a protocol layer 314 on top of the Internet layer 302; and an application layer 312 on top of the protocol layer 314. The Internet layer 302 implements the Transmission Control Protocol and Internet Protocol (TCP/IP) and facilitates Internet communication generally, apart from any blockchain-specific applications. The protocol layer 314 implements the blockchain 112, and comprises a peer-to-peer communication layer 304 used to enable communication between the various servers 104 comprising the blockchain 112 on a peer-to-peer basis; a consensus layer 306 that uses the peer-to-peer communication layer 304 to implement a suitable consensus engine, such as proof-of-work, proof-of-stake, proof-of-authority, or another suitable consensus engine; a distributed ledger layer 308 that uses the consensus layer 306 to add new blocks to the blockchain 112, thereby storing data in those blocks in a distributed fashion across the servers 104; and a settlement engine layer 310 that uses the distributed ledger layer 308 to settle transactions and record evidence of that settlement using the blockchain 112, as discussed further below. The application layer 312 is used to run applications on the blockchain 112. For example, the application layer 312 may be used to implement smart contracts on the blockchain 112 that are able to leverage the functionality of the protocol layer 314 and Internet layer 302. Implementing the settlement engine layer 310 as part of the protocol layer 314 instead of the application layer 312 in at least some example embodiments helps facilitate security by integrating the code for settlement into a lower level of the protocol stack 300, thereby preventing it from being modified by application developers. Additionally, by integrating the settlement engine layer 310 into the protocol layer 314, the assets that are settled using the blockchain 112 are tokenized according to requirements enforced by the blockchain 112's protocol layer. While this limits the flexibility of application developers to design tokenized assets, it helps ensure interoperability for settlement purposes between assets of different types. In other words, any asset compatible with the blockchain 112 may be used for settlement. In contrast, if settlement were implemented using code at the application layer 312 on an asset-by-asset basis, each application could use customized tokens without any guarantee of interoperability of settlement and related functionality. Integrating settlement functionality into the protocol layer 314 also means that for auditing and cybersecurity purposes, only the protocol layer 314 need be considered as opposed to the protocol layer 314 and application layer 312 as would be the case if settlement functionality were implemented in the application layer 312.

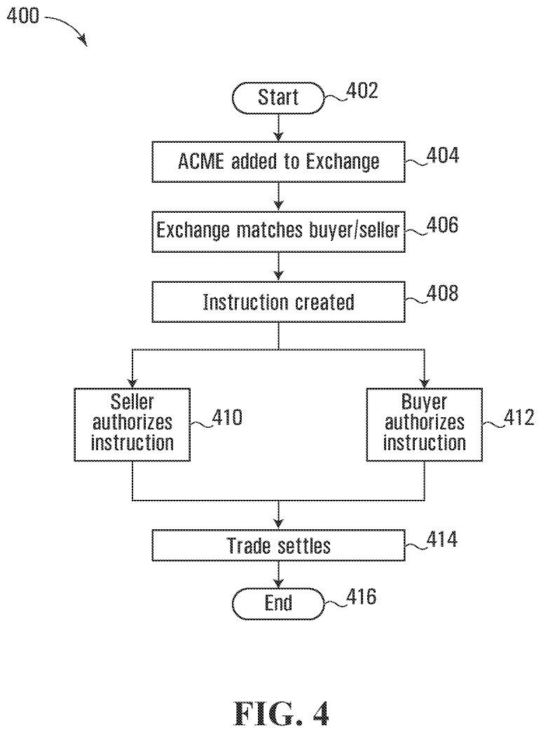

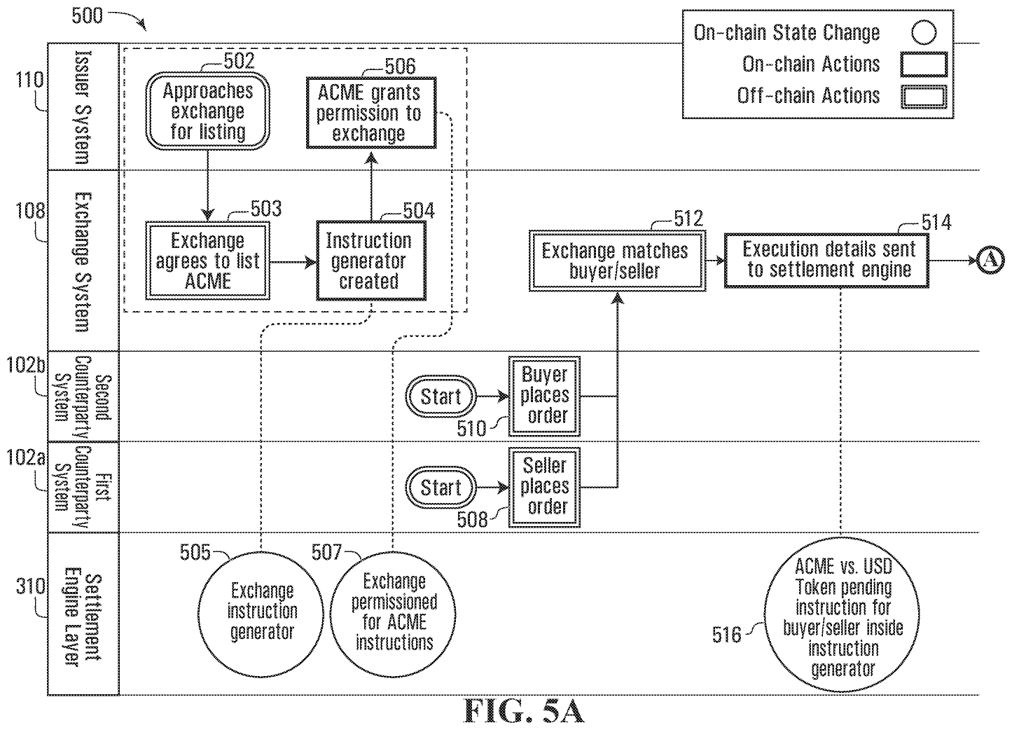

Referring now to FIGS. 4, 5A, and 5B, there is shown in FIG. 4 a flowchart 400 depicting actions taken to effect atomic settlement according to an example embodiment, and in FIGS. 5A and 5B a workflow 500 depicting various on-chain and off-chain actions and state changes taken to effect atomic settlement, according to an example embodiment. In the workflow 500, time increases from left-to-right and various actions and state changes are depicted for each of the issuer system 110, exchange system 108, first counterparty system 102a, second counterparty system 102b, and settlement engine layer 310. In the flowchart 400 and workflow 500, the first counterparty is referred to as the “Seller” and the second counterparty is referred to as the “Buyer”; however, in at least some different example embodiments these roles may be reversed or, particularly with three or more counterparties, the counterparties may be referred to as something other than simply “Buyer” and “Seller”. The flowchart 400 and workflow 500 are used to describe an example operation of the system 100 below.

The flowchart 400 and workflow 500 refer to an “instruction generator”, “instructions”, and “legs”. The instruction generator generates at least one instruction, and each instruction comprises at least one leg.

A “leg” is a data structure that represents a transfer of an asset between counterparties. The leg accordingly specifies the identities of the counterparties and an amount of the asset to be transferred from one of the counterparties to the other of the counterparties. In at least some example embodiments, the leg also specifies the type of asset being transferred (e.g., in embodiments in which multiple asset types are available), and an identifier uniquely identifying the leg within a particular instruction or within the system 100 more generally.

An “instruction” is a data structure specifying an atomic grouping of asset transfers, with each transfer being represented by one leg. An “atomic grouping” of asset transfers means that all of the transfers represented by the legs of the instruction are executed by the settlement engine layer 310, or none of the transfers are executed. This permits DvP to be implemented, as one leg of an atomic grouping can be used to transfer an asset from a first counterparty to a second counterparty, and a second leg of that grouping can be used to transfer payment (another type of asset) from the second counterparty to the first counterparty. An instruction may comprise any one or more of the following as data fields: an identifier, uniquely identifying the instruction within a particular instruction generator or within the system 100 as a whole; a date the instruction was created; a date from which the instruction is valid and an expiry date, between which the settlement engine layer 310 will execute the instruction and before and after which the settlement engine layer 310 will not; a date the instruction was executed, was rejected by at least one of the counterparties and therefore was not executed, or that the settlement engine layer 310 attempted but failed to execute; identifiers (e.g., names) of the counterparties for all legs that comprise part of the instruction; and whether each of those counterparties have authorized the transaction that the instruction represents.

An “instruction generator” is used by the settlement engine layer 310 to generate one or more related instructions. An instruction generator may specify any one or more of the following as data fields: details specifying what, if any, pre-trade activities took place between the counterparties or otherwise; and which parties (the counterparties or otherwise) are permitted to confirm/authorize transfers of assets. In at least some example embodiments, only a creator of an instruction generator can generate instructions using it. While an instruction generator is used to generate one or more instructions in the following examples, in at least some other example embodiments the settlement engine layer 310 may not generate the instruction itself and instead may receive it from, for example, one of the counterparty systems 102, the exchange system 108, or the issuer system 110.

As used in the description of the workflow 500 below, an “action” refers to an operation performed by an entity, with an “off-chain action” being an action performed by an entity other than the blockchain 112, and an “on-chain action” being performed by the blockchain 112, including the settlement engine layer 310. Messages sent to the blockchain 112 comprise data digitally signed by the entity initiating the message, and the signed data is validated and acted upon by the settlement engine layer 310. Messages sent to entities other than the blockchain 112 are typically not digitally signed; however, in some cases the messages may convey digitally signed data for subsequent sending to the blockchain 112.

The workflow 500 starts at block 502, where the issuer system 110 sends a message to the exchange system 108 to request that the exchange system 108 list the ACME asset, which the issuer issues. The exchange system 108 agrees to list the ACME asset at block 503, and proceeds to create an instruction generator at block 504. At block 504, the exchange system 108 sends a digitally signed message to the settlement engine layer 310 on the blockchain 112 to create an instruction generator on the blockchain 112; alternatively, the settlement engine layer 310 may reuse an appropriate existing instruction generator already existing on the blockchain 112. The settlement engine layer 310 creates the instruction generator at block 505, which results in a state change on the blockchain 112 by virtue of the instruction generator being recorded in a block of the blockchain 112.

The exchange system 108 sends a message to the issuer system 110 notifying the issuer system 110 that the instruction generator has been created to transition the workflow 500 from block 504 to 506, where in response to that message the issuer system 110 permissions an entity, that controls an on-chain identity, to use the instruction generator to generate instructions affecting the issuer's asset on the blockchain 112. This permissioning or “whitelisting” of the instruction generator by the issuer system 506 is a one-time event that is committed to and consequently results in a state change of the blockchain 112, as represented by block 507. While the workflow 500 depicts the issuer system 506 actively whitelisting a particular entity to permit it to use the instruction generator, in at least some other embodiments the issuer system 110 may allow all entities to use the instruction generator to generate instructions affecting transfers of the asset that the issuer issues, which the flowchart 400 and workflow 500 refer to as “ACME”. In at least some other example embodiments, permissioning is not expressly performed, and default behavior (e.g. allowing all instruction generators to generate instructions to manage an asset, or only allowing certain pre-defined instruction generators to handle certain assets) is automatically implemented. Collectively, blocks 502-507 of the workflow represent blocks 402 and 404 of the flowchart 400 that refer to the method starting (block 402) and the instruction generator being permissioned to generate instructions dealing with ACME assets (block 404).

Following blocks 506 and 507 of the workflow 500, the first and second counterparty systems 102a,b place an order on the exchange system 108 at blocks 508 and 510 of the workflow 500 respectively. This is done outside of the settlement engine layer 310 and blockchain 112. Each of the counterparty systems 102 messages the exchange system 108, and the exchange system 108 at block 512 in an off-chain action consequently matches the counterparties to each other. In this example, the first counterparty system 102a is transferring ACME assets to the second counterparty system 102b in exchange for USDC assets from the second counterparty system 102b. In the depicted example embodiment, the USDC asset has given blanket authorization to the instruction generator; this may be done through express permission analogous to blocks 506 and 507, or be the USDC asset issuer's default instructions. Block 512 of the workflow 500 corresponds to block 406 of the flowchart 400.

Once the exchange system 108 matches the counterparties to each other, it sends execution details to the settlement engine layer 310 on the blockchain 112 at block 514. The settlement engine layer 310 generates the instruction using the information it receives from the exchange system 108 and, in at least the depicted example embodiment, by adding information such as the status of the instruction and the time at which the instruction is generated. The instruction in this example has two legs: one for transferring the ACME asset from the first counterparty to the second counterparty, and one for transferring the USDC asset from the second counterparty to the first counterparty. The legs are executed atomically to enable DvP. The generation of the instruction on the blockchain 112 by the settlement engine layer 310 is represented by block 516. As the instruction is stored on the blockchain 112, it causes a state change on the blockchain 112. Blocks 514 and 516 of the workflow 500 correspond to block 408 of the flowchart 400.

After the instruction is generated and stored on the blockchain 112, the workflow 500 proceeds to blocks 517 and 518, where the first and second counterparties 102a,b are respectively notified by messages from the exchange system 108 that an instruction requiring their authorization is pending. The first and second counterparty systems 102a,b respectively confirm the instruction is authorized at blocks 520 and 524 by messaging the settlement engine layer 310. While the workflow 500 shows the first counterparty system 102a authorizing the instruction before the second counterparty system 102b, authorization may occur in any order or concurrently between counterparty systems 102. For the first counterparty system 102a, authorizing the instruction comprises locking the amount of the ACME asset specified in the leg transferring the ACME asset to the second counterparty such that it cannot be transferred to anyone but the second counterparty while locked. Analogously, for the second counterparty system 102b, authorizing the instruction comprises locking the amount of the USDC asset specified in the leg transferring the USDC asset to the first counterparty such that it cannot be transferred to anyone but the first counterparty while locked. Locking the assets accordingly means that neither of the counterparty systems 102 can use the locked assets to settle concurrent, unsettled asset transfers. This locking is represented on the workflow 500 as the first counterparty system 102a messaging and causing the settlement engine layer 310 to lock the ACME assets at block 522, which also represents an on-chain state change; and the second counterparty system 102b messaging and causing the settlement engine layer 310 to lock the USDC assets at block 526, which also represents an on-chain state change. These blocks of the workflow 500 correspond to blocks 410 and 412 of the flowchart 400. Additionally, in at least some example embodiments and as discussed further below, the settlement engine layer 310 may confirm the instruction is authorized without explicitly receiving confirmation at this stage of the workflow 500 from a counterparty system if authorization can be inferred (e.g., if that counterparty system generated the instruction and has already locked the asset to be transferred). In at least some example embodiments in which the instruction specifies a date from which it is valid and a date on which it expires, the instruction can only be authorized on or after the date from when it is valid and until it expires. Blocks 410 and 412 of the flowchart 400 respectively represent the first and second counterparties 102a,b authorizing the instruction.

When one of the counterparty systems 102 authorizes the instruction, the settlement engine layer 310 locks the assets by marking them as locked (e.g., by adjusting a data field or flag on the tokenized assets themselves and/or by updating a database specifying whether the assets are locked). The locked assets remain in the custody of the counterparty that owns them. For example, if the counterparties query the balance of their assets, their balance includes the locked assets. By locking the assets, the settlement engine layer 310 places a transfer restriction on those assets that prevents the counterparties from committing to or authorizing any additional instructions that refer to the locked assets. Instructions may still be created that reference the locked assets; however, the counterparties are unable to authorize those instructions unless they unlock their existing assets by cancelling authorization of previously authorized instructions. Alternatively, the counterparties may authorize new instructions using additional assets of the same type that are unlocked.

If any of the counterparty systems 102 refuses to authorize an instruction before the instruction expires, or actively rejects the instruction, the instruction fails to execute and is marked as such, and settlement consequently does not occur. Upon a definitive failing of the instruction to execute, the settlement engine layer 310 releases any assets that were locked in anticipation of settlement.

While in the above-described example embodiment the instruction comprises an expiry date by which the counterparty systems 102 authorize the asset transfer by the instruction's expiry date if settlement is to occur, in at least some other example embodiments the instruction may lack an expiry date. For example, an instruction without an expiry date may stay valid until the counterparty systems 102 authorize the asset transfer, regardless of how long that takes.

The expiry date data field of an instruction may be expressed in any suitable format. For example, the expiry date data field may be populated with a date specified by day, month, and year; it may be populated with a particular time; and/or it may be populated by a particular blockchain block number or height.

In at least some example embodiments, the instruction may specify a date and/or time at which the settlement engine layer 310 will attempt to execute the instruction so long as the counterparty systems 102 have provided their authorization by that date and/or time; if the counterparty systems 102 have not provided their authorization by that date and/or time, the settlement engine layer 310 will not execute the instruction and will mark the instruction as either having failed execution or expired. As with the expiry date data field, this date/time may be expressed in any suitable format, such as a particular block number of the blockchain 112.

Once both of the counterparty systems 102 have authorized the instruction, the instruction settles as an on-chain action at block 528 of the workflow 500. The second counterparty receives the ACME assets from the first counterparty, and this position is updated on the second counterparty system 102b at block 532, and the first counterparty receives the USDC assets from the second counterparty, and this position is updated on the first counterparty system 102a at block 530. This transfer of the USDC assets is recorded on the blockchain 112, thereby changing the blockchain's 112 state as indicated in the workflow 500. Blocks 528, 530, and 532 of the workflow 500 correspond to block 414 of the flowchart 400. The settlement engine layer 310 automatically performs the actions and sends the messages that effect settlement at blocks 528, 530, and 532 of FIG. 5B and block 414 of FIG. 4 without any prompting or initiation by an entity external to the blockchain 112 following the counterparties' 102 authorization of the asset transfers. Following settlement, the flowchart 400 ends at block 416.

### EXAMPLES

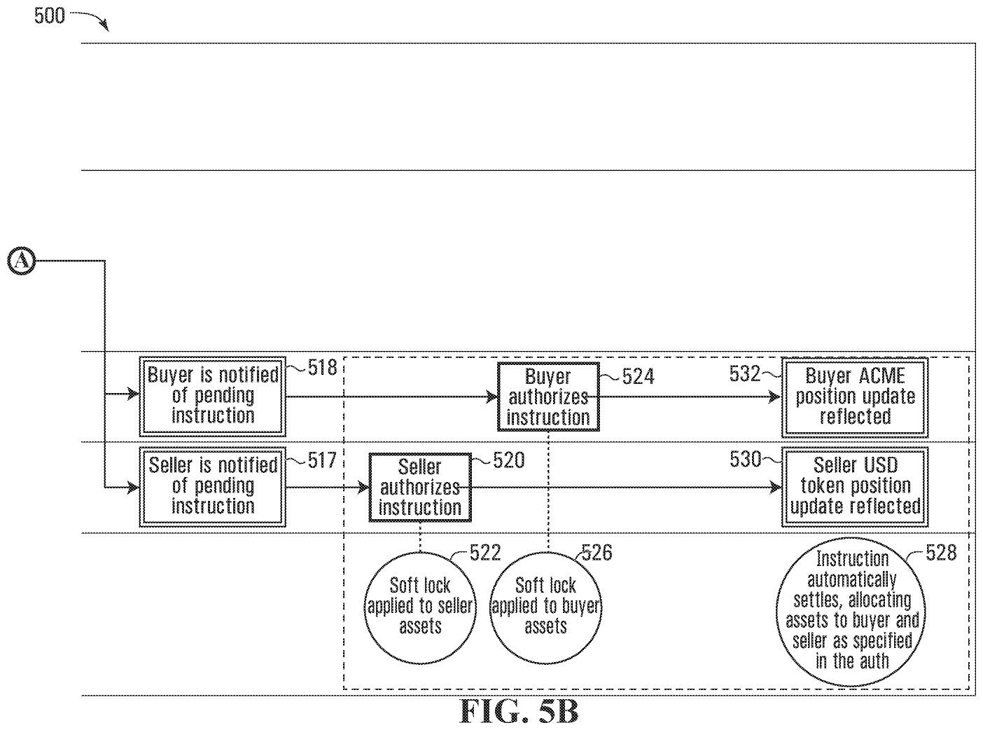

FIGS. 6-9 depict examples of settlement according to various example embodiments.

FIG. 6 depicts an example peer-to-peer settlement in which an instruction generator 600 generates only a first instruction 602a, which contains only a first leg 604a. The first instruction 602a has an identifier of 1 (the “ID” field); an expiry date of 21/01/22 (the “expiry” field); is valid from 01/01/21 (the “valid_from” field); was created on 01/12/20 (the “created” field); specifies as the counterparties as “Alice” and “Bob”; specifies that Alice has authorized the instruction (Alice is associated with a “true” flag); specifies that Bob has not yet authorized the instruction (Bob is associated with a “false” flag); and because the instruction 602a remains valid and has not been authorized by both of the counterparties, that it remains pending (the “Executed” field is set to “Pending”). In this example for peer-to-peer settlement in which Alice generated the instruction 602a, Alice's authorization may be inferred from the fact that Alice generated the instruction 602a and an explicit authorization step analogous to blocks 518, 520, 522, and 524 of the workflow 500 or blocks 410 and 412 of the flowchart 400 is not required.

The leg 604a has an identifier of 1 (the “ID” field); identifies Alice as the first counterparty (the “Payer” field); Bob as the second counterparty (the “Receiver” field); the asset type as ACME (the “Asset” field); and the asset amount as 100 (the “Amount” field). Assuming Bob authorizes the instruction 602a prior to its expiry, the settlement engine layer 310 automatically will transfer 100 of the ACME asset to Bob by executing the leg 604a.

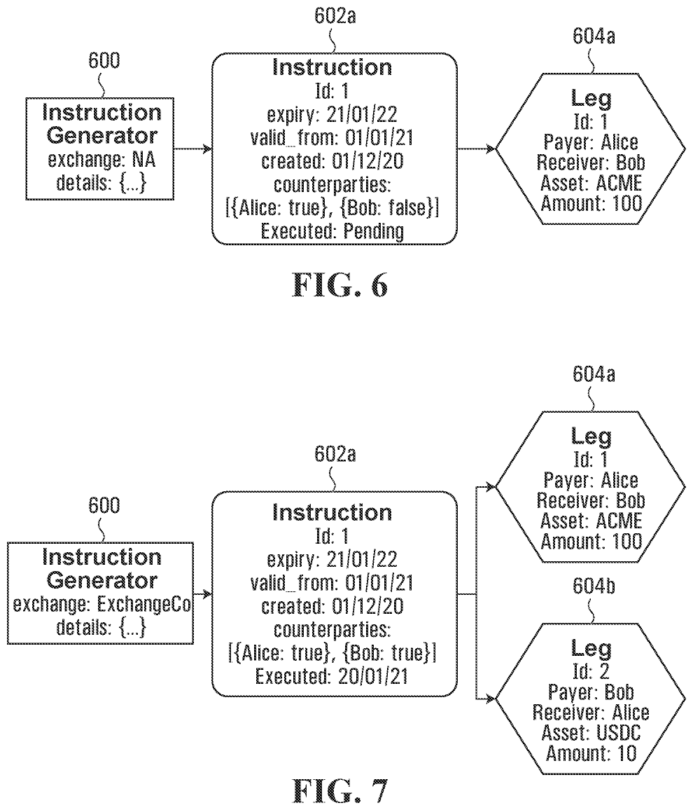

FIG. 7 depicts an example in which the settlement engine layer 310 generates an instruction generator on behalf of (or linked to) the exchange named “ExchangeCo”. As in FIG. 6, the instruction generator 600 generates only the first instruction 602a. In contrast to FIG. 6, the first instruction 602a comprises the first leg 604a and a second leg 604b, which are either both executed or not executed at all. In this example, the counterparties have agreed to a trade off-chain using the exchange system 108, and the exchange system 108 has created the first instruction 602a as described above in respect of the workflow 500 to facilitate settlement.

The instruction generator 600 identifies the name of the exchange that created it as “ExchangeCo”. The instruction 602a has the same data fields and data field values as in FIG. 6, except that in FIG. 7 Bob has authorized the instruction (Bob is associated with a “true” flag instead of a “false” flag in FIG. 6), and the “Executed” field accordingly specifies the execution date as 20/01/21 instead of identifying the instruction 602a as remaining “pending”.

The first leg 604a is identical to the first leg 604a in FIG. 6. The second leg 604b has an identifier of 2 (the “ID” field), distinguishing it from the first leg 604a; identifies Alice as the second counterparty (the “Receiver” field) and Bob as the first counterparty (the “Payer” field), which is the opposite of the first leg 604a; the asset type as USDC (the “Asset” field); and the asset amount as 10 (the “Amount” field).

As both counterparties have authorized this instruction, the settlement engine layer 310 automatically executes the first and second legs 604a,b resulting in 100 of the ACME asset being transferred from Alice to Bob, and 10 of the USDC asset being transferred from Bob to Alice. DvP is enabled by having both payment by both of the counterparties being guaranteed and occurring, for practical purposes, concurrently. Where ACME and USDC represent tokens, FIG. 7 provides an example of an exchange facilitating a token vs. token settlement.

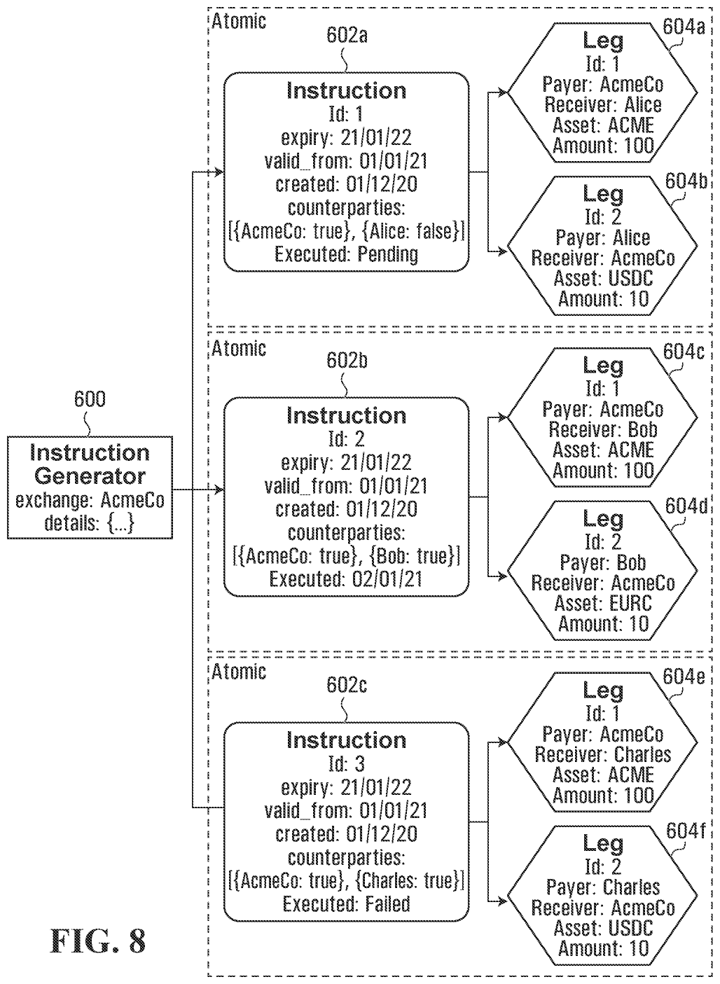

FIG. 8 depicts a primary issuance example in an issuer (“AcmeCo”) is issuing ACME assets, and is distributing those assets directly to investors via first through third instructions 602a-c. The first instruction 602a comprises first and second legs 604a,b; the second instruction 602b comprises third and fourth legs 604c,d; and the third instruction 602c comprises fifth and sixth legs 604e,f. As indicated in FIG. 8, each pair of legs 604a,b, 604c,d, and 604e,f are executed atomically.

The instruction generator 600 identifies the name of its creator as “AcmeCo”. The first instruction 602a specifies that it has an ID of 1; expires on 21/01/22; is valid from 01/01/21; was created on 01/12/20; and AcmeCo and Alice as the counterparties. As AcmeCo is distributing the assets, it is identified as having authorized the instruction; Alice is identified as not yet having approved the instruction. Consequently, the execution status of the first instruction 602a is shown as pending.

The first leg 604a specifies that it has an ID of 1; AcmeCo is the first counterparty; Alice is the second counterparty; the asset being transferred from AcmeCo to Alice are the ACME assets; and 100 of those assets are to be transferred. The second leg 604b specifies that it has an ID of 2; Alice is the first counterparty; AcmeCo is the second counterparty; the asset type being transferred from Alice to AcmeCo is USDC; and that 10 of the USDC are to be transferred.

Once Alice authorizes the first instruction 602a, the settlement engine layer 310 executes both the first and second legs 604a,b of the first instruction 602a. The effect of settlement is that Alice will receive 100 of the ACME assets from AcmeCo and that AcmeCo will receive 10 USDC from Alice as payment, thereby effecting DvP.

The second instruction 602b specifies that it has an ID of 2; expires on 21/01/22; is valid from 01/01/21; was created on 01/12/20; and AcmeCo and Bob as the counterparties. As AcmeCo is distributing the assets, it is identified as having authorized the instruction; Bob is identified as also having approved the instruction. The execution status of the second instruction 602b is accordingly shown as having executed on 02/01/21.

Execution involved atomically executing the third and fourth legs 604c,d. The third leg 604c specifies that it has an ID of 1; AcmeCo is the first counterparty; Bob is the second counterparty; the asset being transferred from AcmeCo to Bob are the ACME assets; and 100 of those assets are to be transferred. The fourth leg 604d specifies that it has an ID of 2; Bob is the first counterparty; AcmeCo is the second counterparty; the asset type being transferred from Alice to AcmeCo is EURC; and that 10 of the EURC are to be transferred. The effect of the second instruction's 602b execution was to transfer 100 ACME assets to Bob from AcmeCo in exchange for 10 of the EURC asset in a DvP transfer.

The third instruction 602c specifies that it has an ID of 3; expires on 21/01/22; is valid from 01/01/21; was created on 01/12/20; AcmeCo and Charles as the counterparties. As AcmeCo is distributing the assets, it is identified as having authorized the instruction; Charles is identified as also having approved the instruction. The fifth and sixth legs 604e,f are identical to the first and second legs 604a,b, with the exception that Alice is replaced with Charles as one of the counterparties.

In contrast to the first and second instructions 602a,b, the execution status of the third instruction 602c is shown as failed. Given that Charles authorized the instruction, an example cause of failure comprises an inability of the settlement engine layer 310 to lock the USDC asset despite Charles's indication to do so.

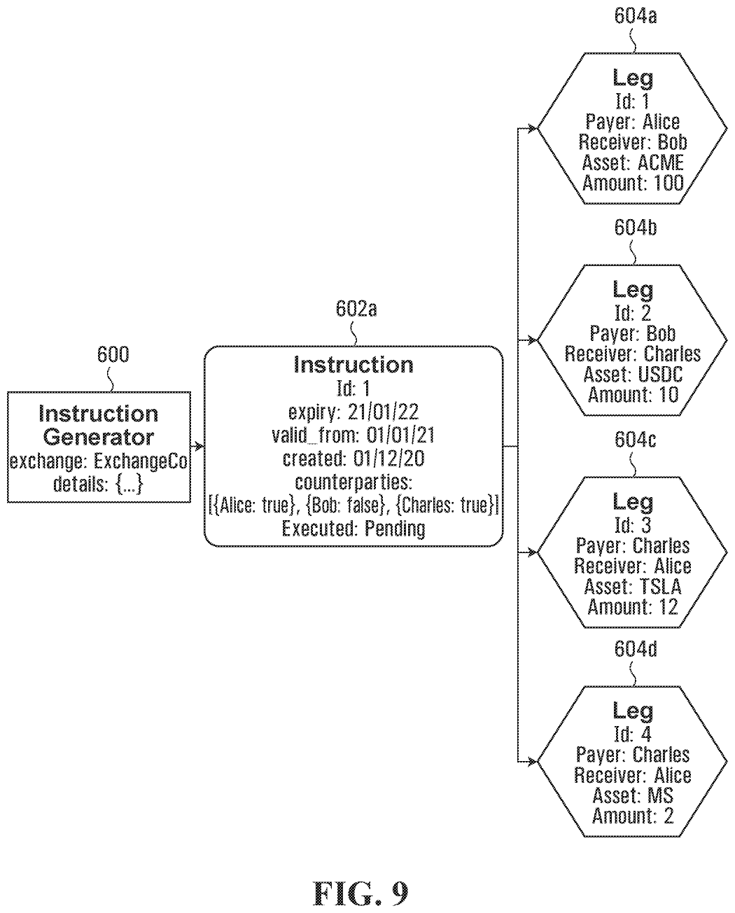

FIG. 9 again depicts an example in which an exchange named “ExchangeCo” generates the instruction generator 600. The instruction generator 600 comprises only the first instruction 602a. The first instruction 602a specifies that it has an ID of 1; it expires on 21/01/22; it is valid from 01/01/21; it was created on 01/12/20; the counterparties as being Alice, Bob, and Charles; Alice and Charles as having authorized the instruction 602a, and Bob as not; and that execution is consequently pending.

The first instruction 602a has first through fourth legs 604a-d, respectively having IDs of 1-4. The first leg 604a specifies Alice is to transfer to Bob 100 of the ACME asset; the second leg 604b specifies that Bob is to transfer to Charles 10 of the USDC asset; the third leg 604c specifies that Charles is to transfer to Alice 12 of the TSLA asset; and the fourth leg 604d specifies that Charles is to transfer to Alice 2 of the MS asset. Upon Bob authorizing the instruction, the settlement engine layer 310 uses the transfers specified in the first through fourth legs 604a-d to determine the net amount payable between the counterparties, and simplifies settlement by transferring only those net amounts. For example, in FIG. 9 if the total value of the 12 TSLA and 2 MS assets is less than 100 ACME assets, settlement can be made more efficient by eliminating the transfers from Charles to Alice; by having Charles transfer the 12 TSLA and 2 MS assets directly to Bob; and by having Alice transfer 100 ACME assets less the value of the 12 TSLA and 2 MS assets to Bob.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

In construing the claims, it is to be understood that the use of computer equipment, such as a processor, to implement the embodiments described herein is essential at least where the presence or use of that computer equipment is positively recited in the claims. It is also to be understood that implementing a blockchain inherently requires computer equipment, such as a processor for creating and authenticating new blocks, storage for storing the blockchain, and a network interface for allowing communication between nodes, which is required for consensus.

One or more example embodiments have been described by way of illustration only. This description is being presented for purposes of illustration and description, but is not intended to be exhaustive or limited to the form disclosed. It will be apparent to persons skilled in the art that a number of variations and modifications can be made without departing from the scope of the claims.

1. A method comprising:
(a) obtaining a first instruction comprising a first leg specifying a first counterparty and a second counterparty that are counterparties to a first transaction and an amount of a first asset owned by the first counterparty;
(b) confirming that the first instruction is authorized, wherein confirming that the first instruction is authorized comprises locking the first asset in response to obtaining confirmation without transferring the first asset;
(c) executing the first instruction after the first instruction is confirmed to be authorized, wherein executing the first instruction comprises transferring the first asset from the first counterparty to the second counterparty; and
(d) recording in a blockchain that the first instruction has been executed.

2. The method of claim 1, wherein:
(a) the first instruction further comprises a second leg specifying the first counterparty, the second counterparty, and an amount of a second asset owned by the second counterparty to be transferred to the first counterparty in exchange for the first asset;
(b) confirming that the first instruction is authorized further comprises locking the second asset in response to obtaining confirmation without transferring the second asset; and
(c) executing the first instruction after the first instruction is confirmed to be authorized further comprises transferring the second asset from the second counterparty to the first counterparty.

3. The method of claim 2, wherein confirming that the first instruction is authorized comprises receiving confirmation from the first and second counterparty systems after the instruction is obtained that the first instruction is authorized.

4. The method of claim 2, wherein locking the second asset comprises recording in the blockchain that the second asset is locked.

5. The method of claim 1, wherein obtaining the first instruction, confirming that the first instruction is authorized, and executing the first instruction are performed using computer program code that implements a protocol layer of the blockchain.

6. The method of claim 1, further comprising generating an instruction generator before obtaining the first instruction, wherein the instruction generator generates the first instruction.

7. The method of claim 6, wherein the first asset is issued by an issuer, and further comprising:
(a) prior to generating the instruction generator comprising the first instruction:
(i) receiving a message from an exchange system to generate the instruction generator; and
(ii) receiving a message from an issuer system granting the instruction generator permission to generate instructions to transfer the first asset; and
(b) recording in the blockchain that the instruction generator has permission to generate the instructions to transfer the first asset.

8. The method of claim 7, further comprising:
(a) prior to generating the instruction generator comprising the first instruction, receiving a message from the exchange system to generate the first instruction and the first leg that specifies the counterparties and the asset to be transferred; and
(b) recording the first instruction in the blockchain.

9. The method of claim 8, further comprising recording in the blockchain a status of the first instruction indicating that the first instruction is pending execution.

10. The method of claim 1, wherein locking the first asset comprises recording in the blockchain that the first asset is locked.

11. The method of claim 1, further comprising:
(a) obtaining a second instruction that comprises a second leg specifying a third counterparty and a fourth counterparty that are counterparties to a second transaction and an amount of a second asset owned by the third counterparty;
(b) confirming that the second instruction is authorized, wherein confirming that the second instruction is authorized comprises locking the second asset in response to obtaining confirmation from the third counterparty system without transferring the second asset;
(c) executing the second instruction after the third and fourth counterparty systems confirm that the second instruction is authorized, wherein executing the second instruction comprises transferring the second asset from the third counterparty to the fourth counterparty; and
(d) recording in the blockchain that the second instruction has been executed.

12. The method of claim 1, further comprising:
(a) obtaining a second instruction that comprises a second leg specifying a third counterparty and a fourth counterparty that are counterparties to a second transaction and an amount of a second asset owned by the third counterparty;
(b) attempting and failing to confirm with third and fourth counterparty systems that the second instruction is authorized; and
(c) in response to failing to confirm that the second instruction is authorized, recording in the blockchain that the second instruction has failed to execute.

13. The method of claim 11, wherein at least one of the counterparties of the first transaction is also at least one of the counterparties of the second transaction.

14. The method of claim 1, wherein:
(a) the first instruction further comprises one or more additional legs that collectively specify one or more additional counterparties to the first transaction and amounts of one or more additional assets to be transferred between the counterparties to the first transaction;
(b) the method further comprises confirming with one or more additional counterparty systems that the first instruction is authorized, wherein confirming with the one or more additional counterparty systems that the first instruction is authorized comprises locking the one or more additional assets in response to obtaining confirming from the one or more additional counterparty systems without transferring the one or more additional assets; and
(c) executing the first instruction comprises:
(i) determining a net amount of the assets to be transferred between the counterparties, wherein determining the net amount comprises setting off amounts owed between the counterparties against each other; and
(ii) transferring the net amount between the counterparties.

15. The method of claim 1, wherein the first instruction automatically executes upon the blockchain achieving a certain block height.

16. The method of claim 1, wherein an agent acts on behalf of at least one of the counterparties.

17. A system comprising multiple servers networked together to form a blockchain, wherein each of the servers comprises:
(a) network interface hardware for interfacing with the other servers;
(b) a non-transitory computer readable medium; and
(c) a processor communicatively coupled to the network interface hardware and the non-transitory computer readable medium, wherein the non-transitory computer readable medium has stored thereon computer program code that is executable by the processor and that, when executed by the processor, causes the processor to perform a method comprising:
(i) obtaining a first instruction comprising a first leg specifying a first counterparty and a second counterparty that are counterparties to a first transaction and an amount of a first asset owned by the first counterparty;
(ii) confirming that the first instruction is authorized, wherein confirming that the first instruction is authorized comprises locking the first asset in response to obtaining confirmation without transferring the first asset;
(iii) executing the first instruction after the first instruction is confirmed to be authorized, wherein executing the first instruction comprises transferring the first asset from the first counterparty to the second counterparty; and
(iv) recording in a blockchain that the first instruction has been executed.

18. The system of claim 17, wherein:
(a) the first instruction further comprises a second leg specifying the first counterparty, the second counterparty, and an amount of a second asset owned by the second counterparty to be transferred to the first counterparty in exchange for the first asset;
(b) confirming that the first instruction is authorized further comprises locking the second asset in response to obtaining confirmation without transferring the second asset; and
(c) executing the first instruction after the first instruction is confirmed to be authorized further comprises transferring the second asset from the second counterparty to the first counterparty.

19. The system of claim 18, wherein confirming that the first instruction is authorized comprises receiving confirmation from the first and second counterparty systems after the instruction is obtained that the first instruction is authorized.

20. A non-transitory computer readable medium having stored thereon computer program code that is executable by a processor and that, when executed by the processor, causes the processor to perform a method comprising:
(a) obtaining a first instruction comprising a first leg specifying a first counterparty and a second counterparty that are counterparties to a first transaction and an amount of a first asset owned by the first counterparty;
(b) confirming that the first instruction is authorized, wherein confirming that the first instruction is authorized comprises locking the first asset in response to obtaining confirmation without transferring the first asset;
(c) executing the first instruction after the first instruction is confirmed to be authorized, wherein executing the first instruction comprises transferring the first asset from the first counterparty to the second counterparty; and
(d) recording in a blockchain that the first instruction has been executed.
